(19) United States
(12) Patent Application Publication
(10) Pub. No.: US 2004/0103703 A1
(43) Pub. Date: Jun. 3, 2004

(54) Bardatchenko method for identifying access rights to objects and to code information input

(76) Inventor: Vitaly Bardachenko, Kiev (UA)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/471,633

(22) PCT Filed: Jul. 10, 2002
(86) PCT No.: PCT/UA02/00028

(30) Foreign Application Priority Data
Jul. 11, 2001 (UA) 2001074869

(51) Int. Cl. E05B 19/18

(52) U.S. Cl. 70/411

(57) ABSTRACT

The invention relates to information carriers operating with control devices, more specifically to methods for identifying and inputting code information which makes it possible to define the access right to different objects or to code information. The aim of said invention is to increase the capacity of code information inputted with the aid of an identifier by developing an updated identification method including techniques which increase the information state of each wafer of the identifier or the identifier in the entirety thereof. The inventive method consists in dialling a code in the identifier with the aid of selective rotation of the elements provided with code marks, periodically modifying said code by rotating a coding wafer at an angle in relation to the normal position thereof in one or another direction and in displacing the wafer to the other orifices which are arranged above or under a central orifice at a distance less than the diameter of said orifices. Said operation can be carried out if the axis on which or around which wafers rotate on one side or together on both sides is embodied in a cut-off form along a certain chord on the cross section orthogonally disposed with respect to said axis.

The invention is relevant to the information storage media that work with controllers. More precisely, it is a method of identification and input of information that identifies the access rights to and labeling of inputted information.

Such methods are subject to fairly contradictive requirements, where simple methods and designs need to be combined with reliable data protection from unauthorized access (further referred to as coded information input for briefness).

Known is an identification method (“information input with variable marker” further omitted), that suggests a permanent code use (Hungarian patent No. 181176, published Dec. 31, 1984, 7/10). Reliability of this method is doubtful, especially in the event or identifier being lost, stolen, or copied.

Additionally, known is the method of object access identification which includes real time code input on the identifier by selective rotation of its elements with code marks, prototype. (Patent of Russian Federation No. 2097519, published Nov. 27, 1997. Bulletin No.33). This method substantially increases number of variants comparing to the previously described one. Known disadvantage of this method, is that in basic example of identifier with single blade, only allows for binary encoding of information, where 2=2 is true for a single plate. In such a design, user is required to use very long binary code and to use identifier with extensive quantity of binary bits, which consequently requires using identifiers with substantially longer compound field that is directly proportional to their linear dimensions. Such design obviously requires a receiver of a larger size as well.

Invention Disclosure This invention goal is to improve the capacity of coded information inputted with identifier due to [symbol] .

Newly developed and improved identification method with additional devices to increase information capacity state per plate of the identifier, and consequently for the whole identifier. The above task is achieved by skewing of the plates from it's normal angle in either direction and movement of the plate to other openings, located above or below of it's normal alignment, for a distance that is smaller than the diameter of affected openings that are located on the axial rod (further referred to as axis) of the whole identifier, while inputting the code by selective rotation of the elements with code markers of identifier. Such design is made possible through the plate rod that is trimmed in the orthogonal to axis section into some chord shape on one or both ends. This allows for additional code capacity of the identifier without increase in the quantity of the plates or their size and the size of the whole identifier.

Brief Description of the Drawings

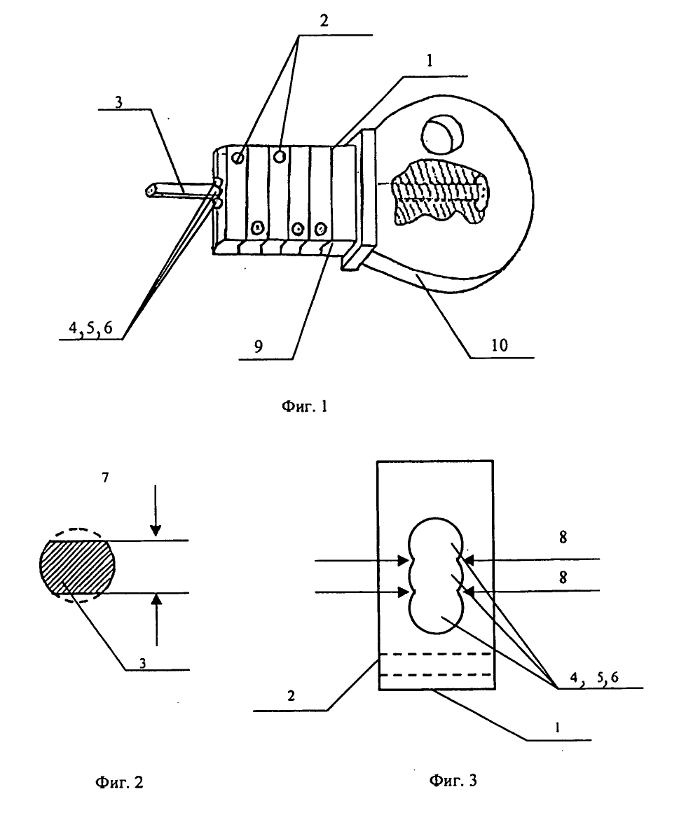

FIG. 1 shows axonometric view of the identifier.

FIG. 2 shows axis of the identifier. FIG. 3 shows plates with code markers shaped as openings

### Embodiment of Invention

Substance of invention is explained in the drawing of the identifier. Plates (1) of the identifiers contain code markers (2) and rotated selectively. Code values of the markers (2), that are located on the opposing surfaces of the plate (1) are different from each other, therefore plate rotation provides for code change (where absence of the marker is also assigned a logical value).

For example, plate (1) is turned by 90 degrees, as shown on FIG. 1, around axis (3), <the rod>may also be shifted in any direction in relation to the face of the plate, which would provide for change of its position relatively to the axis (3), which is the same as change of the code marker (2). Simple calculation shows that the number of code combinations would increase proportionately to the number of openings (4), (5), (6), starting with two and more.

Identifier drawing depicts that if plates is rotates 90 degrees, as in above example, in either direction, due to the decrease in distance (7) of intersection to axis (3), which is less than the distance (8), that is formed on the axis intersecting (4), (5), (6), or others, is now capable of moving into opposite directions in relation to the faces of the plate (1).

Therefore, user should start changing the code by setting the plate (1) in one of the openings (4), (5), (6), or others by rotating the plate around axis (3) in either direction by approximately 90 degrees, and than by moving it in either forward or backward direction in relation to it's face, in relation to the code marker (2). In order to change code for the whole identifier, the above procedure shall be applied, depending on the desired code, to all the plates (1) in the identifier. Described design allows for increased capacity of the code that is inputted from identifier into controlling devices, where information is being read, to significantly improve information protection from unauthorized access.

For convenience, axis (3) of the identifier does not rotate in relation to the <base>(9), while passing through (9) for spring-loaded effect of being fixed to handle (10) of the identifier.

The above proposed method described using the identifier example with double-bladed plates, and with blades that are located on the opposing sides of the plate's axis, that coincides with axis (3) of the identifier. Nevertheless, it is possible to have a design where three or more blades are employed. In such case additional openings (4), (5), (6) and others shall be executed and configured in accordance to plate (1) configuration to ensure required variability of the inputted code .

1. Bardachenka¹ method of rights identification for access to information and input of coded information that contains code input in the identifier by selective rotation of it's elements with code markers, distinctive, because of the additional periodic change of code in the identifier by method of the code plate shift in the opposing direction in the relation to the axis of the identifier, around which code plates are rotated, due to introduction of additional openings in the plate that change code markers (location) in relation to the code reading controller device by the plate rotation in each of the additional opening in it for a specified angle in relation to identifier's base.
